(19) United States
(12) Patent Application Publication
(10) Pub. No.: US 2007/0185659 A1
(43) Pub. Date: Aug. 9, 2007

(54) Apparatus and method for detecting valve mechanical effectiveness in a chemical composition analyzer

(75) Inventor: John Stanley Love, Houston, TX (US)

Correspondence Address: CONLEY ROSE, P.C.;David A. Rose, P. O. BOX 3267, HOUSTON, TX, 77253-3267, US

(73) Assignee: Daniel Industries, Inc., Houston, TX (US)

(21) Appl. No.: 11/350,456

(22) Filed: Feb. 9, 2006

(51) Int. Cl. G06F 19/00

(52) U.S. Cl. 702/35

(57) ABSTRACT

An apparatus for determining whether a mechanical component in a chemical composition analyzer is defective, the apparatus including a mechanical component, a transducer coupled to the mechanical component, the transducer configured to measure a mechanical component property, and a processor in communication with the transducer, the processor configured to determine whether the mechanical component is defective using the mechanical component property. In an embodiment, the processor is configured to compare the mechanical component property to a baseline to determine whether the mechanical component property is within a predetermined range of the baseline, and responsive to the determination that the mechanical component property is not within the predetermined range of the baseline, indicate that the mechanical component is defective. In other embodiments, the mechanical component is a valve and the apparatus is incorporated into a chemical composition analyzer. Also disclosed is a method for determining whether a mechanical component in a chemical composition analyzer is defective.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A chemical composition analyzer is a device that analyzes a material to determine the composition of the material. One common type of chemical composition analyzer is a gas chromatograph, which comprises a chromatography tube and a chromatograph detector. The chromatography tube is a long, thin tube that is typically coiled within the gas chromatograph. An inert gas carries a sample of the material along the chromatography tube, where the sample breaks up into different molecules. The molecules have different molecular weights and pass through the chromatography tube at various rates, such that the lighter molecules exit the chromatography tube before the heavier molecules. As the molecules exit the chromatography tube, they are analyzed by the chromatograph detector to determine the abundance and molecular weight of each type of molecule. The chromatograph detector, known to one skilled in the art, is connected to a data output device, such as a monitor, printer or computer, that displays the results of the sample analysis. The results of the sample analysis are generally in the form of a chromatogram, which is a chart that has time on the X-axis, the abundance (typically measured in millivolts) on the Y-axis, and a variable-height line with one or more peaks graphed on the two axes. Scientists and engineers can determine the chemical composition of the sample based on the data in the chromatogram. Alternatively, the gas chromatograph can be configured to automatically determine the chemical composition of the sample based on the data in the chromatogram.

An important component in any chemical composition analyzer is the apparatus that controls the amount of sample that enters the chemical analysis portion of the chemical composition analyzer. For example, in the case of a gas chromatograph, the valve that controls the amount of sample allowed into the chromatography tube has to be precise, sometimes on the order of ±0.1 μL, otherwise the resulting data will be erroneous. If the valve sticks, opens or closes too quickly or too slowly, or otherwise does not operate properly, then the valve will allow too much or too little sample into the chromatography tube. Because the chromatograph detector measures the abundance of molecules with specific masses, if the amount of sample entering the chromatography tube is too high or too low, the chromatogram produced by the gas chromatograph will be erroneous. Thus, there is a need to monitor valve operations within a gas chromatograph to ensure that the valve operates correctly so that the resulting chemical composition data output is correct.

The prior art methods of monitoring valve operation in the gas chromatograph are not preferred because they are unreliable and provide too little data. The prior art method of verifying correct valve operation is to calibrate the gas chromatograph before every use. However, verifying correct valve operation through calibration of the gas chromatograph only detects valve defects if they occur during the calibration process. If the valve problem is intermittent, the problem is not always identified during calibration, which can lead to erroneous data output. Moreover, even if a defective valve is identified during calibration, mere identification of the defective valve does not provide any information as to the history of the valve's action. It would be beneficial for the technician replacing the valve to be able to obtain detailed information regarding the valve's operation, such as the history of the valve's action. Consequently, a need exists for a method for continuously and accurately monitoring the valve in the chemical composition analyzer, preferably during operation of the analyzer, and an apparatus to accomplish the same.

### BRIEF DESCRIPTION OF THE DRAWINGS

For a more complete understanding of the present invention, and for further details and advantages thereof, reference is now made to the accompanying drawings, in which:

FIG. 1 is a block diagram of one embodiment of a chemical composition analyzer of the present invention;

FIG. 2A is a section view of an example of the valve of the present invention in the open configuration;

FIG. 2B is a section view of an example of the valve of the present invention in the closed configuration; and

FIG. 3 is a flow sheet of the logic used by one embodiment of Valve Evaluation Program of the present invention.

### DETAILED DESCRIPTION

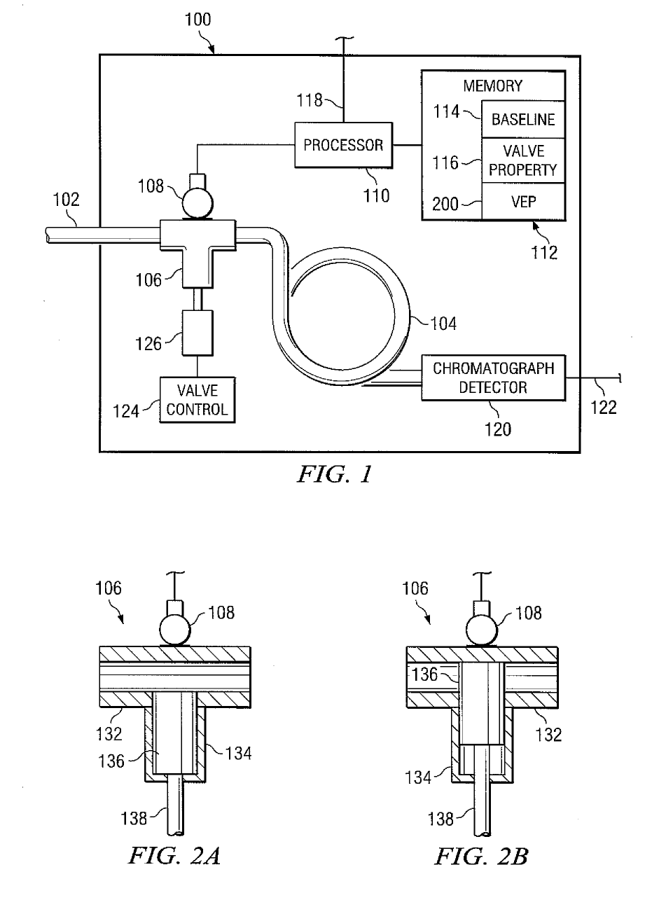

FIG. 1 is a block diagram of one embodiment of a chemical composition analyzer, specifically a gas chromatograph, incorporating the invention. As with a traditional gas chromatograph, the gas chromatograph 100 of the present invention comprises an inlet tube 102, am actuator 126, a valve 106, a valve control 124, a chromatography tube 104, a chromatograph detector 120, and a data output line 122. However, the gas chromatograph 100 shown in FIG. 1 has been modified to include the present invention, which includes a transducer 108 attached to the valve 106, a processor 110, a data output line 118, and a memory 112 comprising a baseline 114, a valve property 116, and a valve evaluation program 200. The invention allows the gas chromatograph 100 to monitor the operation of the valve 106 every time the valve 106 opens or closes and reduces the likelihood of erroneous output due to defective valve 106 operations.

The valve 106 will now be described in greater detail. The valve 106 is a device that regulates the amount of material that passes into the analysis section of a chemical composition analyzer, such as the chromatography tube 104. The valve 106 may be any one of various types of valves, such as gate, ball, globe, butterfly, needle, diaphragm, or angle valves. The valve 106 may have any number of ports so that the sample can be directed to various locations. The valve 106 should not be limited to traditional valves, but includes any apparatus that regulates, impedes, or is able to stop the flow of material into the analysis section of a chemical composition analyzer. The present invention should not be limited to the valves described herein and persons of ordinary skill in the art will appreciate that the present invention includes valves other than those specifically described herein.

FIGS. 2A and 2B illustrate the action of the valve 106 moving from the open configuration to the closed configuration. As can be seen in FIGS. 2A and 2B, the valve 106 comprises a valve body 132, a gate 136, a gate housing 134, and a shaft 138. In the open configuration shown in FIG. 2A, the material sample (not shown) flows through the valve body 132 from the inlet side on the left to the outlet side on the right. Alternatively, the material sample may flow from right to left. In the open configuration, the gate 136 is recessed into the gate housing 134 such that the material sample flows through the valve 106 unimpeded. When the actuator 126 (shown in FIG. 1) receives a command to close the valve 106, the actuator 126 displaces the shaft 138, and the gate 136 moves into the closed configuration shown in FIG. 2B. In the closed configuration, the gate 136 is no longer recessed in the gate housing 134, but instead moves into the valve body 132 such that the gate 136 substantially blocks the flow of sample material through the valve 106. When the actuator 126 receives a command to open the valve 106, the process is reversed and the gate 136 returns to the open configuration shown in FIG. 2A. The present invention should not be limited to the opening and closing action described herein and persons of ordinary skill in the art will appreciate that the present invention includes opening and closing actions other than those specifically described herein.

During its normal operations, the valve 106 produces various sounds, referred to herein as valve properties. When the valve 106 opens and closes, the gate 136 slides across the gate housing 134 and the valve body 132 making a distinct sound. The specific type of sound that the gate 136 makes indicates how well the gate 136 is seated against the gate housing 134 and the valve body 132. When the valve 106 closes, the end of the gate 136 opposite of the shaft 138 contacts the inside wall of the valve body 132, producing another distinct sound. Similarly, when the valve 106 opens, the end of that gate 136 attached to the shaft 138 contacts the inside wall of the gate housing 136, producing yet another distinct sound. If the gate 136 bounces against the valve body 132 or the gate housing 134 when the valve 106 opens or closes, then the bounce produces a different sound. When the valve 106 is in the closed configuration and the gate 136 does not completely seal the inlet side of the valve body from the outlet side of the valve body 132, the sample material (not shown) is able to bypass the gate 136 and flow through the valve 106. Because gasses and liquid make a sound when they pass through orifices, fixtures, cracks, or other small passages, the sample material makes a specific sound as it bypasses the gate 136. Furthermore, if the valve 106 has a leak such that the material sample escapes the valve 106 into the gas chromatograph 100 (shown in FIG. 1), the material sample will make a sound as it escapes the valve 106. Any of these sounds may be used as a valve property for the purposes of the present invention. The present invention should not be limited to the sound-related valve properties described herein and persons of ordinary skill in the art will appreciate that the present invention includes sound-related valve properties other than those specifically described herein.

In an alternative embodiment, the processor 110 or transducer 108 can be connected to the valve control 124 (shown in FIG. 1) and configured with a clock (not shown) such that the valve property may be the time between the occurrence of two events. For example, in the present embodiment one valve property is the time required for the valve to open, close, or open and close. Another valve property may be the time that occurs between the valve control 124 instructing the actuator 126 (shown in FIG. 1) to open or close the valve and the valve actually opening or closing. The present invention should not be limited to the time-related valve properties described herein and persons of ordinary skill in the art will appreciate that the present invention includes time-related valve properties other than those specifically described herein.

In other alternative embodiments, the valve property may be a vibration or other indications produced by the valve 106. For example, the valve 106 produces different types of vibrations when it opens and closes. More specifically, the valve 106 produces vibrations when the gate 136 contacts the valve body 132 when the valve 106 closes, when the gate 136 contacts the valve body 132 when the valve 106 closes, and when the gate 136 slides against the valve body 132 and the gate housing 134 when the valve 106 opens and closes. All of these vibrations may be valve properties. Alternatively, the valve 106 may be configured with a position indicator to indicate whether the valve is open, partially open, or closed. Thus, the position of the valve as indicated by an indicator may be a valve property. In a further alternative embodiment, the valve 106 can be configured with optical devices to indicate various conditions of the valve, such as view windows on the inlet and outlet side of the valve body 134 or an optical device that determines whether material is flowing through the valve 106. These vibration, position, and optical properties are also valve properties. The present invention should not be limited to the valve properties described herein and persons of ordinary skill in the art will appreciate that the present invention includes valve properties other than those specifically described herein.

The valve property may be configured to be a single piece of data or a plurality of pieces of data. For example, if the valve property is a sound, the valve property may be the specific level, such as one decibel, of the sound. Alternatively, the valve property may be an acoustical spectrum of a plurality of sounds at different frequencies. Such acoustical spectrums are well known in the art and typically have a range of different acoustical wavelengths along the X-axis, the amplitude of the wave on the Y-axis, and a variable-height line with one or more peaks graphed on the two axes. Furthermore, the valve properties may change over time. For example, the acoustical spectrum may change over time if the sound is not a constant. The transducer 108 is able to detect any of the above described valve properties, convert the valve property into an electrical signal, and transmit the electrical signal to the processor 110 (shown in FIG. 1) for storage in the memory 112. The present invention should not be limited to the valve property configurations described herein and persons of ordinary skill in the art will appreciate that the present invention includes valve property configurations other than those specifically described herein.

With reference to FIGS. 1, 2A, and 2B, the transducer 108 will now be described in greater detail. The transducer 108 is an apparatus that measures a valve property and transforms the valve property into an electrical signal that is transmitted to the processor 110. In one embodiment, the transducer 108 may be a microphone configured to monitor the sounds made by the valve 106 when it opens and closes. In alternative embodiments, the transducer 108 may measure time or vibration, position, or optical properties within the valve 108, or any other valve properties not specifically discussed herein. The transducer 108 converts the valve property into electronic data and transmits the electronic data to the memory 112 for storage as valve property 116. The present invention should not be limited to the transducer described herein and persons of ordinary skill in the art will appreciate that the present invention includes transducers other than those specifically described herein.

The transducer 108 may be located on any part of the valve 106. The transducer 108 may be attached to the valve body 132, as shown in FIGS. 1, 2A, and 2B. However, the transducer 108 may alternatively be located at other locations on the valve body 132 or on the gate 136, the gate housing 134, or the shaft 138. The transducer 108 may be integrated into the valve 106 when the valve 106 is manufactured, or alternatively, the transducer 108 may be mounted onto the valve 106 using an adhesive or any other attachment means. The present invention should not be limited to the transducer configurations described herein and persons of ordinary skill in the art will appreciate that the present invention includes transducer configurations other than those specifically described herein.

Referring back to FIG. 1, the processor 110 and memory 112 will now be described in greater detail. The processor 110 may be any logic performing circuitry that can interface with the transducer 108, the memory 112, and a data output device (not shown) via the data output 118. The memory 112 may be any type of storage media suitable for storing the baseline 114, the valve property 116, and the Valve Evaluation Program 200 described herein. The data output 118 allows the processor 110 to upload or download data from the memory 112 to an external device, such as a computer. The data that the processor 110 can upload or download includes the baseline 114, the valve property 116, the Valve Evaluation Program 200, or any other data stored in the memory 112. Persons of ordinary skill in the art are aware of several types of processors 110 and memory 112 that are suitable for the invention described herein.

The processor 110 and memory 112 may be stand alone components or may be integrated with the transducer 108. In one embodiment, the processor 110 and memory 112 may be stand alone components that may be individually added to or removed from the gas chromatograph 100. In another embodiment, the processor 110 and memory 112 may be integrated with the processor and memory (not shown) used by the valve control 124 or the chromatograph detector 120. In yet another embodiment, the processor 110 and the memory 112 are integrated with the transducer 108 in the valve 106. Integrating the processor 110, the memory 112, and the transducer 108 together is advantageous because it allows the present invention to be added to prior art valves in existing gas chromatographs. Moreover, the transducer 108, the processor 110, and the memory 112 may be integrated with the valve 106 such that prior art valves in existing gas chromatographs may be replaced with a single-piece valve 106, processor 110, memory 112, and transducer 108. When the processor 110, the memory 112, and the transducer 108 are integrated together, they contain the data output 118 such as a plug that can be connected to the other circuitry within the gas chromatograph 100 or to a data output device (not shown). The present invention should not be limited to the processor and memory described herein and persons of ordinary skill in the art will appreciate that the present invention includes processors and memory other than those specifically described herein.

In addition to the valve property 116, another piece of data stored within the memory 112 is the baseline 114. When the valve 106 is operating properly, the baseline 114 is identical or substantially similar to the valve property 116. In one embodiment, the baseline 114 may be created at the manufacturing facility where the valve 106 is manufactured. In such an embodiment, the baseline 114 may be created while the valve 106 is operating within its specified tolerances. In an alternative embodiment, the baseline 114 may be created from empirical data developed from the valve properties 116. For example, during calibration or at other times when the valve 106 is known to be operating correctly, the valve property 116 may be used to create a baseline 114. The present invention should not be limited to the baseline creation methods described herein and persons of ordinary skill in the art will appreciate that the present invention includes baseline creation methods other than those specifically described herein.

Once created, the baseline 114 is not necessarily fixed. Although it is within the scope of the invention that the baseline 114 remains the same once created, it is also within the scope of the present invention that the baseline 114 be adjustable based on valve properties 116 received over time. More specifically, the baseline 114 may be adjusted based on trends that form in the valve properties 116. For example, in the embodiment where the valve property 116 is the sound created by the valve 106, the valve 106 may initially make a specific sound while opening and closing, but may make a different sound during opening and closing once the valve 106 is broken in. In such a case the valve 106 may still be operating correctly, however the valve 106 may be making a different sound than was made by the valve 106 when it was originally manufactured. It is also conceivable that the valve manufacturer or another entity would discover certain indicators that appear before the valve 106 fails or otherwise does not operate correctly. It is therefore within the scope of the present invention that the baseline 114 is updatable so that it can include the indicators that appear before the valve 106 fails or otherwise does not operate correctly. Persons of ordinary skill in the art are aware of other situations where it will be advantageous to update the baseline 114. The present invention should not be limited to the baseline update methods described herein and persons of ordinary skill in the art will appreciate that the present invention includes baseline update methods other than those specifically described herein.

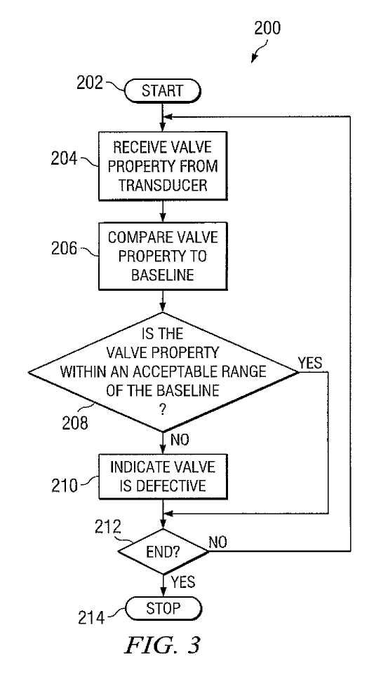

A third piece of data stored in the memory 112 is the Valve Evaluation Program 200. The Valve Evaluation Program 200 may be a program executed by the processor 110 that compares the valve property to the baseline 114 to determine whether the valve 106 is operating correctly. FIG. 3 is an example of a flow sheet of the logic of the Valve Evaluation Program 200. The Valve Evaluation Program 200 starts at 202 when the gas chromatograph 100 is operating. At 204, the Valve Evaluation Program 200 receives the valve property 116 from the transducer 108. The valve property 116 is typically stored in the memory 112 for permanent storage, but may also be stored in memory 112 temporarily until the valve property 116 is compared to the baseline 114 by the Valve Evaluation Program 200.

At 206, the Valve Evaluation Program 200 compares the valve property 116 to the baseline 114 to determine the extent to which the valve property 116 deviates from the baseline 114. Minor deviations of the valve property 116 from the baseline 114 do not necessarily indicate that the valve 106 is defective. Persons of ordinary skill in the art will appreciate that the valve property 116 may have some variation from the baseline 114 when the valve 106 is operating properly because the valve 106 may not open and close in exactly the same manner with every open and close cycle. Thus, the Valve Evaluation Program 200 is configured to compare the valve property 116 to the baseline 114 and determine whether the valve property 116 falls outside of a predetermined range of deviation from the baseline 114. Persons of ordinary skill in the art know how to configure the predetermined range of deviation between the valve property 116 and the baseline 114. However, for the purposes of explanation and not to be construed in a limiting sense, the predetermined range may be any one of a 1, 2, 5, 10, 20, or 50 percent deviation from the baseline 114. Persons of ordinary skill in the art will appreciate that such a deviation may occur for a single value of the valve property or may occur over several frequencies of the valve property 116 if the valve property 116 is an acoustical spectrum or other multi-value valve property. At 208, the Valve Evaluation Program 200 then determines whether the valve property 116 is within the predetermined range of the baseline 116 at 208. If the Valve Evaluation Program 200 determines that the valve property 116 is within the predetermined range of the baseline 116, then the Valve Evaluation Program 200 proceeds to 212. If the Valve Evaluation Program 200 determines that the valve property 116 is not within the predetermined range of the baseline 116, then the Valve Evaluation Program 200 proceeds to 210.

At 210, the Valve Evaluation Program 200 indicates that the valve 106 is defective. The Valve Evaluation Program 200 may indicate that the valve 106 is defective by sending a signal to a data output device (not shown) via the data output 118 (shown in FIG. 1). Examples of data output devices that can be used to indicate that the valve is defective are lights, buzzers, klaxons, monitors, printers, diagnostic programs, telecommunication devices, and other output devices not specifically listed herein. Of course, persons of ordinary skill in the art will appreciate that the aforementioned list of data output devices is not exclusive and that the present invention should not be limited to the data output devices described herein. Once the Valve Evaluation Program 200 has indicated that the valve 106 is defective, the Valve Evaluation Program 200 proceeds to 212 where the Valve Evaluation Program 200 determines whether the Valve Evaluation Program 200 should end. The Valve Evaluation Program 200 should end when the gas chromatograph 100 (shown in FIG. 1) is shut down or otherwise in a sleeping or non-active state. If the Valve Evaluation Program 200 determines that the Valve Evaluation Program 200 should not end, then Valve Evaluation Program 200 returns to 204. If the Valve Evaluation Program 200 determines that the Valve Evaluation Program 200 should end, the Valve Evaluation Program 200 ends at 214.

Although the embodiments herein are described in conjunction with a gas chromatograph, persons of ordinary skill in the art will appreciate that the present invention may be implemented on other types of chemical composition analyzers. More specifically, the present invention is useful for any type of valve-containing apparatus in which precise valve operation is an important feature of the apparatus. The present invention may also be useful on any device that contains a mechanical component and in which detailed operating information and/or monitoring of any mechanical component property is desired. Persons of ordinary skill in the art will appreciate that the present invention may be used in a variety of other applications.

While a number of preferred embodiments of the invention have been shown and described herein, modifications thereof may be made by one skilled in the art without departing from the spirit and the teachings of the invention. The embodiments described herein are exemplary only and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

1. An apparatus for determining whether a mechanical component in a chemical composition analyzer is defective, the apparatus comprising:
a mechanical component mounted within an enclosed chemical composition analyzer;
a transducer coupled to the mechanical component, the transducer configured to directly measure an intrinsic mechanical component property; and
a processor in communication with the transducer, the processor configured to determine whether the mechanical component is defective using the intrinsic mechanical component property.

2. The apparatus of claim 1 wherein the processor is further configured to determine whether the mechanical component is defective when the intrinsic mechanical component property changes in response to use of the mechanical component.

3. The apparatus of claim 1 wherein the processor is configured to compare the intrinsic mechanical component property to a baseline to determine whether the intrinsic mechanical component property is within a predetermined range of the baseline, and indicate that the mechanical component is defective in response to the determination that the intrinsic mechanical component property is not within the predetermined range of the baseline.

4. The apparatus of claim 1 wherein the mechanical component is a valve and the intrinsic mechanical component property is a valve property.

5. The apparatus of claim 3 wherein the baseline is created at least one of when the mechanical component is manufactured and using empirical data from the mechanical component.

6. The apparatus of claim 3 wherein the baseline is adjustable to account for changes in the intrinsic mechanical component property over time.

7. The apparatus of claim 3 wherein the intrinsic mechanical component property is a sound.

8. The apparatus of claim 7 wherein the sound is at least one of the mechanical component opening, the mechanical component closing, a gas leak, and a liquid leak.

9. The apparatus of claim 3 wherein the intrinsic mechanical component property is at least one of the time required for the mechanical component to perform an action and the amount of time between the transmission of a control signal for the mechanical component to perform an action and the completion of the action.

10. (canceled)

11. The apparatus of claim 1 wherein the mechanical component is a valve and the intrinsic mechanical component property is a valve property, and further comprising:
a chromatography tube;
wherein the valve is configured to allow a predetermined amount of a sample into the chromatography tube;
an actuator that opens and closes the valve; and
a valve control configured to instruct the actuator when to open and close the valve to allow the predetermined amount of sample into the chromatography tube.

12. The apparatus of claim 11 wherein the processor is configured to compare the valve property to a baseline to determine whether the valve property is within a predetermined range of the baseline, and indicate that the valve is defective in response to the determination that the valve property is not within the predetermined range of the baseline.

13. An apparatus comprising:
a valve;
a transducer coupled to the valve, the transducer configured to directly measure a sound caused by a valve event, the valve event being identified prior to the direct sound measurement; and
a processor in communication with the transducer, the processor configured to compare the sound to a baseline to determine whether the sound is within a predetermined range of the baseline, and indicate that the valve is defective in response to the determination that the sound is not within the predetermined range of the baseline.

14. The apparatus of claim 13 wherein the baseline is created at least one of when the valve is manufactured and using empirical data from the valve.

15. The apparatus of claim 13 wherein the baseline is adjustable to account for changes in the valve property over time.

16. The apparatus of claim 13 wherein the valve event is at least one of the valve opening, the valve closing, a gas leak, and a liquid leak.

17. A method of determining whether a mechanical component mounted within an enclosed chemical composition analyzer is defective, the method comprising:
disposing a transducer adjacent the mechanical component;
operating the chemical composition analyzer;
actuating the mechanical component;
measuring directly an intrinsic mechanical component property while operating the chemical composition analyzer;
determining whether the mechanical component is defective using the intrinsic mechanical component property;
indicating the mechanical component defectiveness.

18. The method of claim 17 further comprising:
observing a change in the intrinsic mechanical component property; and
indicating that the mechanical component is defective in response to the observing a change.

19. The method of claim 17 further comprising:
comparing the intrinsic mechanical component property to a baseline;
determining whether the intrinsic mechanical component property is within a predetermined range of the baseline; and
indicating that the mechanical component is defective in response to the determination that the intrinsic mechanical component property is not within the predetermined range of the baseline.

20. The method of claim 19 further comprising:
creating the baseline upon at least one of manufacture of the mechanical component and receipt of empirical data from the mechanical component; and
adjusting the baseline to account for changes in the intrinsic mechanical component property over time.
